(19) United States
(12) Patent Application Publication
(10) Pub. No.: US 2023/0388596 A1
(43) Pub. Date: Nov. 30, 2023

(54) TECHNIQUES FOR GENERATING RECOMMENDATIONS BASED ON HISTORICAL USER PREFERENCES AND CURRENT USER INTERACTIONS

(71) Applicant: NETFLIX, INC., Los Gatos, CA (US)

(72) Inventors: Moumita BHATTACHARYA, San Jose, CA (US); Sudarshan Dnyaneshwar LAMKHEDE, Sunnyvale, CA (US); Christoph KOFLER, Los Gatos, CA (US); Kelley Jean ROBINSON, Redwood City, CA (US); Yi ZHANG, Hayward, CA (US)

(21) Appl. No.: 18/325,959

(22) Filed: May 30, 2023

Related U.S. Application Data
(60) Provisional application No. 63/347,491, filed on May 31, 2022.

(51) Int. Cl. H04N 21/466; H04N 21/25; H04N 21/482

(52) U.S. Cl. CPC H04N 21/4668; H04N 21/251; H04N 21/4826

(57) ABSTRACT

In various embodiments, an in-session recommendation application generates recommendations for users during streaming sessions. The in-session recommendation application generates a set of feature values for a set of features associated with a trained machine learning model based on user interactions that have occurred via a graphical user interface (GUI) during a current streaming session. The in-session recommendation application executes the trained machine learning model on at least the set of feature values and a first feature value associated with a first item to generate a first score. The in-session recommendation application generates a recommendation based on the first score and at least a second score that is associated with both a second item and the user interactions. The in-session recommendation application displays the recommendation within the GUI.

### CROSS-REFERENCE TO RELATED APPLICATIONS

This application claims priority benefit of the U.S. Provisional Patent Application titled, “IN-SESSION ADAPTATION OF RECOMMENDATIONS,” filed on May 31, 2022, and having Ser. No. 63/347,491. The subject matter of this related application is hereby incorporated herein by reference.

### BACKGROUND

### Field of the Various Embodiments

The various embodiments relate generally to computer science and to data search and retrieval and, more specifically, to techniques for generating recommendations based on historical user preferences and current user interactions.

### Description of the Related Art

A graphical user interface (GUI) for a typical streaming media service provides a variety of mechanisms to enable a user to select a media title of interest to the user from a catalog of media titles and to control the playback of the selected media title for viewing. For example, personalized recommendations of media titles are oftentimes automatically generated and displayed within a GUI at the beginning of each browsing/streaming session. Because personalized recommendations can directly impact the ability of a given user to select a media title of interest to that user, generating personalized recommendations that align with the actual interests of that user is an important aspect of the overall media streaming experience.

In one approach to generating personalized recommendations, a machine learning model is trained and periodically re-trained to predict the likelihoods that different users are going to watch various media titles based on historical preferences of a multitude of users and metadata describing a multitude of media titles. Historical preferences are determined based on preference-related data that is logged as users engage with the streaming media service over relatively long periods of time prior to training. Some examples of preference-related data are streaming histories and user ratings of media titles. To generate personalized recommendations for a given user, the trained machine learning model is used to predict the likelihoods that the given user is going to watch various media titles. The predicted likelihoods reflect the historical preferences of the user and other users having similar historical preferences. The media titles associated with the highest predicted likelihoods are then displayed within the GUI as personalized recommendations.

One drawback of the above approach is that, because the historical preferences of a given user do not necessarily correlate to the actual interests of that user during a particular streaming session, the predicted likelihoods might not fully capture the user intent for that streaming session. In cases where the predicted likelihoods do not fully capture the user intent, the usefulness of the personalized recommendations can be reduced or rendered ineffective. As a result, the user can end up having to browse media titles in an inefficient, ad-hoc fashion, which can substantially reduce the likelihood that the user actually ends up selecting and watching a media title that is of interest to the user. For example, if a user wanted to watch an anime movie despite never having watched any anime movies before, and the personalized recommendations omitted anime movies, then the user could end up having to manually browse through titles of anime movies, become discouraged with the overall search process, and exit the streaming session without watching any media titles.

As the foregoing illustrates, what is needed in the art are techniques for generating more accurate recommendations for users during streaming sessions.

### SUMMARY

One embodiment sets forth a computer-implemented method for generating recommendations for users during streaming sessions. The method includes generating a first set of feature values for a first set of features associated with a trained machine learning model based on a first set of user interactions that have occurred via a first graphical user interface (GUI) during a current streaming session; executing the trained machine learning model on at least the first set of feature values and a first feature value associated with a first item to generate a first score; generating a first recommendation based on the first score and at least a second score that is associated with both a second item and the first set of user interactions; and displaying the first recommendation within the first GUI.

At least one technical advantage of the disclosed techniques relative to the prior art is that, with the disclosed techniques, personalized recommendations can be generated and displayed within a GUI during a streaming session based on historical preferences and user interactions that have occurred during that streaming session. In that regard, with the disclosed techniques, a machine learning model is implemented that is trained to generate personalized recommendations for a given user that account for both the historical preferences of that user as well as the interactions of that user during a current streaming session. Because the interactions of a user that occur during a given streaming session usually correlate to the actual interests of that user, the accuracy, and therefore usefulness, of personalized recommendations that are based on those interactions can be increased relative to recommendations that are generated using prior art techniques. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 sets forth exemplary illustrations of ranked item lists that can be generated by the in-session recommendation application of FIG. 1 at different points-in-time during a streaming session, according to various embodiments;

FIG. 3 is a flow diagram of method steps for displaying personalized recommendations within a graphical user interface (GUI) during a streaming session, according to various embodiments; and

FIG. 4 is a flow diagram of method steps for generating a ranked item list, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

### System Overview

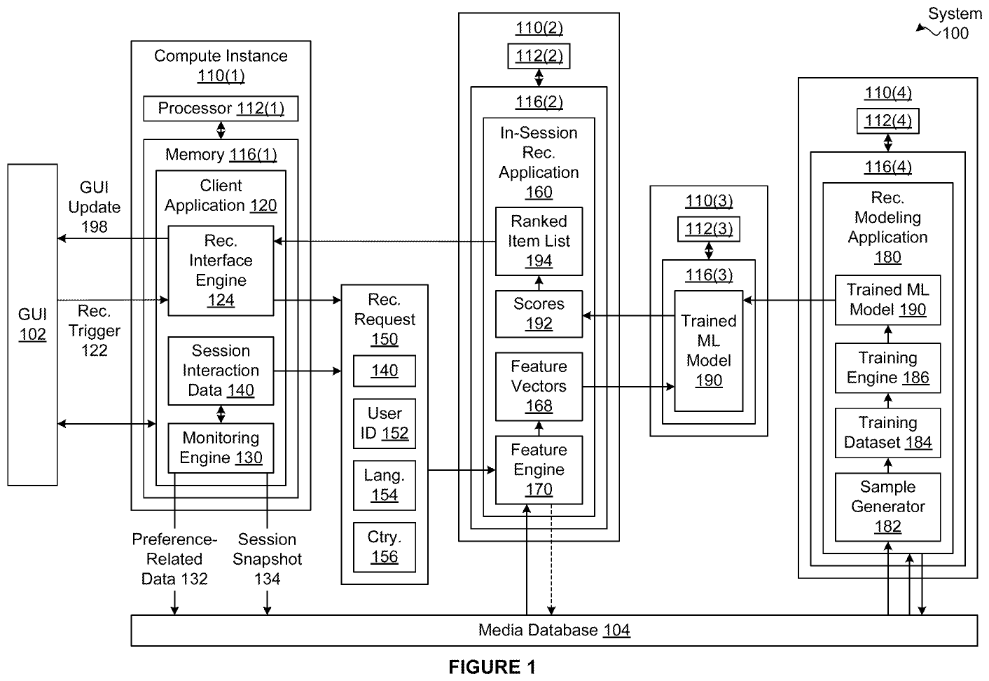

FIG. 1 is a conceptual illustration of a system 100 configured to implement one or more aspects of the various embodiments. As shown, in some embodiments, the system 100 includes, without limitation, a compute instance 110(1)-a compute instance 110(4), a media database 104, and a graphical user interface (GUI) 102. For explanatory purposes, the compute instance 110(1)-the compute instance 110(4) are also referred to herein individually as “the compute instance 110” and collectively as “the compute instances 110.”

In some other embodiments, the system 100 can omit one or more of the compute instances, the media database 104, or any combination thereof. In the same or other embodiments, the system 100 can further include, without limitation, one or more other compute instances, any number and/or types of other databases, or any combination thereof.

The components of the system 100 can be distributed across any number of shared geographic locations and/or any number of different geographic locations and/or implemented in one or more cloud computing environments (i.e., encapsulated shared resources, software, data, etc.) in any combination.

As shown, the compute instance 110(1)-the compute instance 110(4) includes, without limitation, a processor 112(1)-112(4), respectively, and a memory 116(1)-116(4), respectively. For explanatory purposes, the processor 112(1)-the processor 112(4) are also referred to herein individually as “the processor 112” and collectively as “the processors 112.” The memory 116(1)-the memory 116(4) are also referred to herein individually as “the memory 116” and collectively as “the memories 116.” Each compute instance (including each compute instance 110) can be implemented in a cloud computing environment, implemented as part of any other distributed computing environment, or implemented in a stand-alone fashion.

The processor 112 can be any instruction execution system, apparatus, or device capable of executing instructions. For example, the processor 112 could comprise a central processing unit, a graphics processing unit, a controller, a micro-controller, a state machine, or any combination thereof. The memory 116 of the compute instance 110 stores content, such as software applications and data, for use by the processor 112 of the compute instance 110. The memory 116 can be one or more of a readily available memory, such as random-access memory, read only memory, floppy disk, hard disk, or any other form of digital storage, local or remote.

In some other embodiments, any number of compute instances can include any number of processors and any number of memories in any combination. In particular, any number of compute instances (including zero or more of the compute instances 110) can provide a multiprocessing environment in any technically feasible fashion.

In some embodiments, a storage (not shown) may supplement or replace the memory 116 of the compute instance 110. The storage may include any number and type of external memories that are accessible to the processor 112 of the compute instance 110. For example, and without limitation, the storage can include a Secure Digital Card, an external Flash memory, a portable compact disc read-only memory, an optical storage device, a magnetic storage device, or any suitable combination of the foregoing.

In general, each compute instance (including each compute instance 110) is configured to implement one or more software applications. For explanatory purposes only, each software application is described as residing in the memory 116 of a single compute instance and executing on the processor 112 of the same compute instance. However, in some embodiments, the functionality of each software application can be distributed across any number of other software applications that reside in the memories of any number of compute instances and execute on the processors of any number of compute instances in any combination. Further, subsets of the functionality of multiple software applications can be consolidated into a single software application.

In particular, the compute instance 110(1) is configured to enable a user to select a media title of interest to the user from a catalog of media titles and to control the playback of the selected media title for viewing via the GUI 102. Some examples of media titles are a movie, an episode of a television show, a video game, and a podcast. The GUI 102 can be any type of user interface that allows users to interact with one or more software applications via any number and/or types of graphical elements. To increase the ability of a given user to select a media title of interest to that user, the compute instance 110(1) is configured to generate and display within the GUI 102 personalized recommendations of media titles.

As described previously herein, in one conventional approach to generating personalized recommendations of media titles, a machine learning model is trained to predict the likelihoods that different users are going to watch various media titles based on historical preferences of many users and metadata describing the media titles. To generate personalized recommendations for a given user, the conventionally-trained machine learning model is used to predict the likelihoods that the given user is going to watch various media titles. The media titles associated with the highest predicted likelihoods are then displayed within a conventional GUI as personalized recommendations.

One drawback of the above approach is that, because the historical preferences of a given user do not necessarily correlate to the actual interests of that user during a particular streaming session, the predicted likelihoods can be inaccurate for that streaming session. As used herein, a “streaming session” refers to a continuous period of user engagement with a streaming media service that is bounded by inactivity for a certain period (e.g., thirty minutes) irrespective of whether a media title is actually streamed during the streaming session. In cases where the predicted likelihoods are inaccurate, the usefulness of the personalized recommendations can be reduced or rendered ineffective.

### Personalized Recommendations that Account for User Interactions

To address the above problems, the compute instance 110(1) implements a client application 120 that, during each streaming session, generates and displays within the GUI 102 personalized recommendations that account for historical preferences of a user, user interactions during that streaming session, and optionally user interactions associated with any number of historical streaming sessions associated with the user. As described in greater detail below, in some embodiments, the client application 120 can generate and display within the GUI 102 any number of recommendation requests during each streaming session.

As persons skilled in the art will recognize, the techniques described herein are illustrative rather than restrictive and can be altered and applied in other contexts without departing from the broader spirit and scope of the inventive concepts described herein. For example, the techniques described herein can be modified and applied to generate recommendations associated with any type of item based on user interactions detected or user intents identified during an interactive networking session.

As shown, the client application 120 resides in the memory 116(1) of the compute instance 110(1) and executes on the processor 112(1) of the compute instance 110(1). The client application 120 can perform any number and/or types of operations to display and monitor any number and/or types of interactive GUI elements and/or any number and/or types of non-interactive GUI elements within the GUI 102. In some embodiments, each interactive GUI element enables one or more types of user interactions that automatically trigger corresponding user events. Some examples of types of interactive GUI elements include, without limitation, scroll bars, buttons, text entry boxes, drop-down lists, and sliders. In some embodiments, the client application 120 organizes GUI elements into one or more container GUI elements (e.g., panes). The client application 120 includes, without limitation, a monitoring engine 130, session interaction data 140, and a recommendation (rec.) interface engine 124.

As part of initializing a new streaming session, the monitoring engine 130 launches a background process that monitors the GUI 102 during the streaming session to detect user interactions that occur via the GUI 102. During the streaming session, the monitoring engine 130 incrementally generates and/or determines the session interaction data 140 based on the detected user interactions. As shown, the client application 120 stores the session interaction data 140 locally in the memory 116(1). The session interaction data 140 includes and/or is derived from, without limitation, a set of user interactions that have occurred via the GUI 102 during a current streaming session. As used herein, a “current streaming session” refers to a streaming session that is in-progress (i.e., has started but has not completed).

The client application 120 can perform any number and/or types of processing operations on the detected user interactions to generate the session interaction data 140. For instance, in some embodiments, the client application 120 incrementally generates and appends to the session interaction data 140 timed-stamped browsing data specifying media titles, genres, categories, or any combination thereof, that are browsed by the user throughout the streaming session. In the same or other embodiments, the client application 120 incrementally generates and appends to the session interaction data 140 any amount and/or types of data indicating an amount of time spent hovering over each of any number of items (e.g., media titles), a selection of one or more items, or an amount of time spent streaming each of one or more items. As used herein, the amount of time spent hovering over an item (e.g., a media title) refers to an amount of time that a user has spent hovering over a thumbnail that represents the item within the GUI 102 during the streaming session. The client application 120 can interpret any number and/or types of user interactions as a selection of an item. For instance, in some embodiments, the client application 120 interprets a click on a thumbnail representing an item within the GUI 102 as a selection of the item.

When the client application 120 determines that the streaming session is no longer active (e.g., when a period of inactivity exceeds a predetermined session limit), the client application 120 generates a session snapshot 134 and any amount and or type of associated metadata based on the session interaction data 140. In some embodiments, the session snapshot 134 is at least a subset of the session interaction data 140. The client application 120 stores the session snapshot 134 in the media database 104. A session snapshot (including the session snapshot 134) is also referred to herein as a “snapshot of user interactions” and a “snapshot” and includes, without limitation, a set of user interactions that occurred via a GUI during an associated streaming session and/or any amount and/or types of data derived from the set of user interactions. In some embodiments, the client application 120 can store the session snapshot 134 directly or indirectly in any number and/or types of memories that are accessible to the in-session recommendation application 160 instead of or in addition to storing the session snapshot 134 in the media database 104.

The monitoring engine 130 also launches a background process that monitors the GUI 102 during the streaming session to generate any amount and/or types of preference-related data 132 based on the user interactions that occur via the GUI 102 during the streaming session. The preference-related data 132 includes, without limitation, any amount and/or types of explicit user preferences and any amount and/or types of inferred user preferences. An example of an explicit user preference is a user rating of an item (e.g., a media title). An example of an implicit user preference is a viewing history associated with a user. A viewing history is also referred to herein as a “streaming history.” The granularity of the preference-related data 132 is lower than both the granularity of the session interaction data 140 and the granularity of the session snapshot 134.

Throughout the streaming session, the client application 120 monitors the GUI 102 and/or the session snapshot 134 in order to detect recommendation triggers. The client application 120 can interpret any number and/or types of events and/or user interactions as recommendation triggers. In some embodiments, the client application 120 interprets user interactions corresponding to a user logging into a streaming media service via the GUI 102 as a recommendation trigger. In the same or other embodiments, the client application 120 interprets user interactions corresponding to a user navigating to a home page or a search page within the GUI 102 as a recommendation trigger. In the same or other embodiments, the client application 120 interprets user interactions corresponding to scrolling or navigating within the GUI 102 as a recommendation trigger.

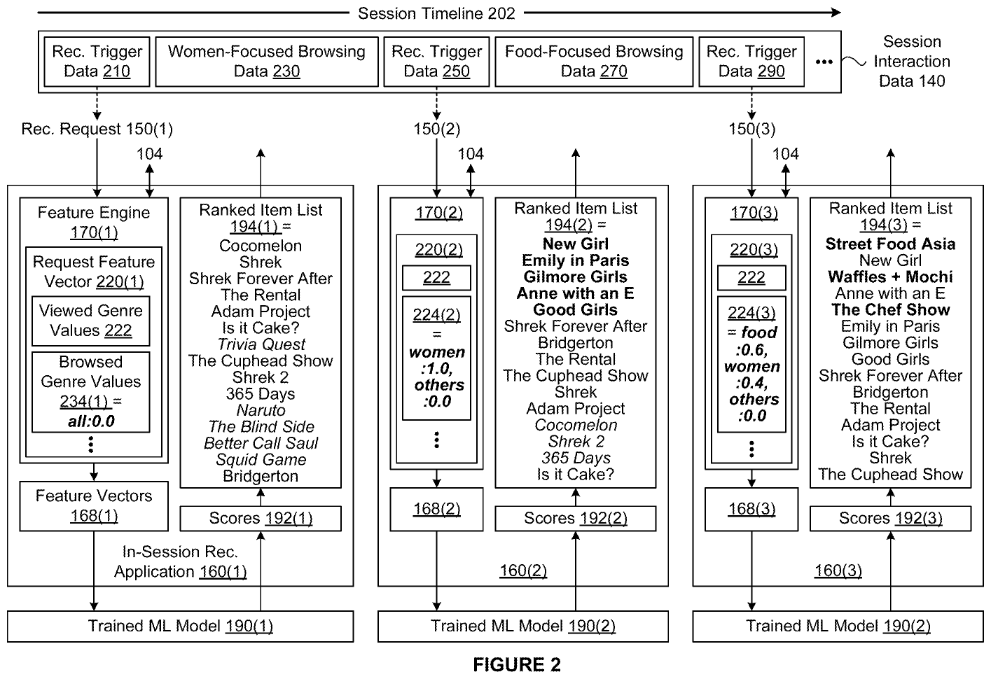

Upon detecting a recommendation trigger, the client application 120 causes the recommendation interface engine 124 to generate a personalized recommendation and perform a GUI update 198 that causes at least a portion of the personalized recommendation to be displayed via the GUI 102. For explanatory purposes, the functionality of the recommendation interface engine 124 and the in-session recommendation application 160 are described in greater detail in conjunction with FIG. 1 in the context of performing a GUI update 198 in response to a recommendation trigger 122. In some embodiments, the GUI update 198 displays within the GUI 102 any number and/or types of GUI elements that graphically depict a recommendation specifying one or more of the highest-ranked media titles in the ranked item list. As described in greater detail below in conjunction with FIG. 2, in the same or other embodiments, the client application 120 performs a sequence of multiple different GUI updates in response to a sequence of multiple recommendation triggers detected at different point-in-time during the streaming session.

As shown, the recommendation interface engine 124 generates and transmits to an in-session recommendation application 160 a recommendation (rec) request 150 based on the recommendation trigger 122. The recommendation request 150 includes, without limitation, a copy of the session interaction data 140, a user identifier (ID) 152, a language 154, and a country 156. The user ID 152, the language 154, and the country 156 identify a user, a language, and a country, respectively, that are associated with the streaming session. In some other embodiments, the recommendation request 150 can include any amount and/or types of contextual data instead of or in addition the user ID 152, the language 154, the country 156, or any combination thereof. Notably, the copy of the session interaction data 140 represents user interactions that occur from the beginning of the streaming session through the point-in-time associated with the recommendation trigger 122.

As shown, in response to the recommendation request 150, the in-session recommendation application 160 generates and transmits to the recommendation interface engine 124 a ranked item list 194. The ranked item list 194 specifies a highest-ranked subset of the media titles included in that catalog as per associated scores and optionally the associated scores. The score associated with a media title predicts a likelihood that a user corresponding to the user ID 152 is going to stream the media title during the streaming session. The in-session recommendation application 160 is described in greater detail below in conjunction with FIG. 1 in the context of the recommendation request 150 and in greater detail in conjunction with FIG. 2 in the context of generating multiple ranked item lists.

The recommendation interface engine 124 generates a personalized recommendation based on the ranked item list 194 and performs the GUI update 198 that causes at least a portion of the ranked item list 194 to be displayed within the GUI 102. The recommendation interface engine 124 can generate any type of personalized recommendation in any technically feasible fashion. In some embodiments, the recommendation interface engine 124 sets the personalized recommendation equal to any portion (including all) of the ranked item list 194. In some other embodiments, the recommendation interface engine 124 performs any number and/or types of processing operations (e.g., filtering operations, organization operations, categorization operations) on the ranked item list 194 to generate the personalized recommendation. A personalized recommendation is also referred to herein as a “recommendation” and a “recommendation for a user.”

As shown, the in-session recommendation application 160 resides in the memory 116(2) of the compute instance 110(2) and executes on the processor 112(2) of the compute instance 110(2). Upon receiving the recommendation request 150 from the recommendation interface engine 124 the in-session recommendation application 160 generates the ranked item list 194 and transmits to the recommendation interface engine 124 a response that includes the ranked item list 194.

As shown, the in-session recommendation application 160 includes, without limitation, a feature engine 170, feature vectors 168, scores 192, and the ranked item list 194. The feature engine 170 computes the feature vectors 168 based on the recommendation request 150 and the media database 104. Each of the feature vectors 168 is associated with both the recommendation request 150 and a different media title included in a catalog of media titles. Each of the feature vectors 168 corresponds to a set of features associated with the trained machine learning model 190. More precisely, each of the feature vectors 168 includes a different feature value for each feature associated with the trained machine learning model 190.

As shown, the trained machine learning model 190 resides in the memory 116(3) of the compute instance 110(3) and executes on the processor 112(3) of the compute instance 110(3). The trained machine learning model 190 maps a feature vector associated with both a media title and a recommendation request to a score. The score predicts a likelihood that a user corresponding to a user ID specified in the recommendation request is going to stream the media title during a streaming session associated with the recommendation request.

For explanatory purposes, each feature associated with the trained machine learning model is referred to herein as either an item feature (e.g., year since release, total hours that item is streamed in a country) or a request feature (e.g., similarity of a title with the last title the user “thumbed up” in the current session). As described in greater detail below, as part of generating each version of the machine learning model 190, the recommendation modeling application 180 computes a different item feature vector for each media title included in a catalog of media titles based on associated metadata. Each item feature vector includes a different value for each item feature associated with the trained machine learning model 190. The recommendation modeling application 180 stores the item features in the media database 104.

In operation, the feature engine 170 retrieves from the media database 104 a different item feature vector (not shown) for each media title included in a catalog of media titles and preference-related data associated with the user ID 152. The feature engine 170 also retrieves from the media database 104 the X most recent session snapshots associated with the user ID 152, where X is equal to the minimum of a predetermined cross-session limit and the total number of session snapshots associated with the user ID 152. The X most recent session snapshots are also referred to here as “cross-session snapshots” with respect to the recommendation request 150. A cross-session snapshot includes and/or is derived from, without limitation, a set of user interactions that occurred during a historical streaming session. As used herein, a historical streaming session refers to a streaming session that has completed.

For each request feature, the feature engine 170 computes a different feature value based on at least one of the session interaction data 140, the preference-related data associated with the user ID 152, the cross-session snapshots, the language 154, or the country 156. The feature engine 170 aggregates the feature values for the request features to generate a request feature vector (not shown) associated with the recommendation request 150.

The feature engine 170 generates the feature vectors 168 based on the request feature vector and the item feature vectors. More precisely, for each media title in the catalog of media titles, the feature engine 170 aggregates the item feature vector associated with the media title and the request feature vector associated with the recommendation request 150 to generate a feature vector that is associated with both the media title and the recommendation request 150.

As shown, the in-session recommendation application 160 executes the trained machine learning model 190 on each of the feature vectors 168 to generate the scores 192. Each of the scores 192 is generated based on a different feature vector and therefore is associated with a different media title. The score associated with a given media title predicts a likelihood that a user corresponding to the user ID 152 is going to stream the media title during the streaming session associated with the recommendation request 150.

The in-session recommendation application 160 ranks and optionally filters the media titles based on the scores 192 to generate the ranked item list 194. The ranked item list 194 specifies the N media titles included in that catalog that are associated with the N highest of the scores 192 and optionally the associated scores. The in-session recommendation application 160 transmits to the client application 120 a response that includes the ranked item list 194, thereby fulfilling the recommendation request 150.

As depicted with a dashed line, in some other embodiments, the in-session recommendation application 160 stores in the media database 104 any number of feature values of any number of request features for re-use. In particular, the in-session recommendation application 160 can store any feature value of a request feature that is not computed based on the session interaction data 140 and re-use the stored feature value when generating a request vector associated with any other recommendation request associated with the same streaming session.

Advantageously, because the interactions of a user that occur during a given streaming session usually correlate to the actual interests of that user, the accuracy, and therefore usefulness, of personalized recommendations that the client application 120 provides based on those interactions can be increased relative to recommendations that are generated using prior art techniques. Furthermore, unlike recommendations that are generated using prior art techniques, the client application 120 can effectively personalize recommendations at various different points-in-time during a first streaming session for a new user based on the interactions of the new user despite an absence of preference-related data associated with the new user.

As shown, the recommendation modeling application 180 generates the trained machine learning model 190 based on preference-related data associated with any number of users, session snapshots associated with any number of historical streaming sessions, and metadata associated with any number of media titles. Metadata associated with one or more media title(s) is also referred to herein as “item metadata.” The recommendation modeling application 180 can perform any number and/or types of machine learning operations on any type of untrained or partially trained machine learning model to generate the trained machine learning model 190. For instance, in some embodiments, the trained machine learning model 190 can be a trained version of a long short-term memory network, a bi-directional long short-term memory network, a recurrent neural network, a transformer model, a multi-layer perceptron, an ensemble model (e.g., a machine learning model that includes one or more other machine learning models), or any other type of machine learning model.

Prior to generating each version of the trained machine learning model 190, the recommendation modeling application 180 computes a different item feature vector for each media title included in a catalog of media titles. For each media title, the recommendation modeling application 180 retrieves from the media database 104 any amount and/or types of associated metadata and then computes an item feature vector based on the associated metadata. Each item feature vector includes a different value for each feature that is associated with the trained machine learning model 190. The recommendation modeling application 180 stores the item feature vectors in the media database 104.

As shown, the recommendation modeling application 180 includes a sample generator 182, a training dataset 184, a training engine 186, and the trained machine learning model 190. The sample generator 182 generates the training dataset 184 based on any number of the item feature vectors, preference-related data associated with any number of user IDs, session snapshots associated with any number of historical streaming sessions, and any number of item feature vectors. The sample generator 182 can acquire the preference-related data and the session snapshots in any technically feasible fashion. In some embodiments, the sample generator 182 retrieves from the media database 104 the preference-related data associated with all users and session snapshots associated with historical streaming sessions that occurred no more than a training cutoff (e.g., 60 days) before a current date and time.

The training dataset 184 includes any number of positive training samples and any number of negative training samples. Each positive training sample includes a feature vector and a correct score of 1. Each negative training sample includes a feature vector and a correct score of 0. To generate the training dataset 184, the sample generator 182 identifies any number of positive training examples and randomly determines any number of negative training examples based on the retrieved session snapshots. Each positive training example specifies both a media title and a session snapshot corresponding to a historical streaming session during which the media title was streamed. Each negative training example specifies both a media title and a session snapshot corresponding to a historical streaming session during which the media title was not streamed.

The sample generator 182 generates a different positive training sample for each positive training example, where each positive training sample includes a different feature vector and a correct score of 1. The sample generator 182 generates a different negative training sample for each negative training example, where each negative training sample includes a different feature vector and a correct score of 0. For explanatory purposes only, positive training samples and negative training samples are also referred to herein collectively as “training examples” and individually as a “training example.” Similarly, positive training examples and negative training examples are also referred to herein collectively as “training examples” and individually as a “training example.”

To generate a feature vector for a given training sample, the sample generator 182 selects the session snapshot and the media title that are specified in the given training example. The sample generator 182 determines training session interaction data, a user ID, and contextual information based on the selected snapshot and optionally any amount and/or types of associated metadata. The sample generator 182 retrieves from the media database 104 preference-related data associated with the user ID. The sample generator 182 designates X of the session snapshots associated with the user ID as cross-section snapshots, where X is equal to the minimum of a predetermined cross-session limit and the total number of session snapshots associated with the user ID that temporally precede the selected session snapshot in time. The cross-section snapshots are a subset of the session snapshots associated with the user ID that most closely precede the selected session snapshot in time.

The sample generator 182 computes a request feature vector for the given training sample based on the training session interaction data, the preference-related data associated with the user ID, the contextual information, and the cross-session snapshots. The sample generator 182 aggregates the request feature vector and the item feature vector associated with the selected media title to generate the feature vector for the given training sample. As persons skilled in the art will recognize, the sample generator 182 and the feature engine 170 implement the same definitions (e.g., equations, algorithms) for the features associated with the trained machine learning model 190 to compute the feature vectors associated with, respectively, training and executing the trained machine learning model 190.

The training engine 186 generates the trained machine learning model 190 based on the training dataset 184. More specifically, in some embodiments, the training engine 186 executes a gradient descent algorithm over the training dataset 184 to train an untrained version of a multi-layer perceptron. The training engine 186 executes the gradient descent algorithm in a mini-batch fashion for any number of epochs based on any batch size and any number and/or types of hyperparameters. The multi-layer perceptron implements a sigmoid activation function to compute the score. During each batch, the gradient descent algorithm updates learnable parameters included in the multi-layer perceptron based on a binary cross entropy loss associated with the batch.

Many modifications and variations on the functionality of the exemplary iterative learning algorithm, the recommendation modeling application 180, the sample generator 182, the training dataset 184, the training engine 186, and the trained machine learning model 190 as described herein will be apparent to those of ordinary skill in the art without departing from the scope and spirit of the described embodiments. For instance, in some embodiments, the recommendation modeling application 180 trains an untrained sequence model (e.g., a long short-term memory network) based on sequences of time-ordered feature vectors instead of independent feature vectors. Each sequence of feature vectors corresponds to a temporal interaction sequence associated with a user within a streaming session, across a sequence of streaming sessions, or both. The in-session recommendation application 160 and the feature engine 170 are modified accordingly.

As persons skilled in the art will recognize, the techniques described are illustrative rather than restrictive and can be altered without departing from the broader spirit and scope of the invention. Many modifications and variations on the functionality of the GUI 102, the client application 120, the monitoring engine 130, the recommendation interface engine 124, the in-session recommendation application 160, the feature engine 170, the trained machine learning model 190, the exemplary iterative learning algorithm, the recommendation modeling application 180, the sample generator 182, the training dataset 184, and the training engine 186 as described herein will be apparent to those of ordinary skill in the art without departing from the scope and spirit of the described embodiments. Further, in various embodiments, any number of the techniques disclosed herein may be implemented while other techniques may be omitted in any technically feasible fashion. Similarly, many modifications and variations on the media database 104, the preference-related data 132, the session snapshot 134, the cross-session snapshots, the recommendation request 150, the scores 192, the ranked item list 194, the feature vectors 168, and the training dataset 184 as described herein will be apparent to those of ordinary skill in the art without departing from the scope and spirit of the described embodiments.

It will be appreciated that the system 100 shown herein is illustrative and that variations and modifications are possible. For example, in some embodiments, any portions (including all) of the functionality provided by client application 120 and the in-session recommendation application 160 can be integrated into or distributed across any number of software applications (including one). In particular, in some embodiments, the functionality provided by the recommendation interface engine 124 and/or the monitoring engine 130 as described herein is integrated into the in-session recommendation application 160. Further, the connection topology between the various units in FIG. 1 can be modified as desired.

### Generating Different Ranked Item Lists

FIG. 2 sets forth exemplary illustrations of ranked item lists that can be generated by the in-session recommendation application 160 of FIG. 1 at different points-in-time during a streaming session, according to various embodiments. As described previously herein in conjunction with FIG. 1, the client application 120 incrementally generates the session interaction data 140 during a streaming session. The in-session recommendation application 160 generates each ranked item list in response to a different recommendation request received from the client application 120 at a different point-in-time during the streaming session. Each recommendation request includes a different version of the session interaction data 140 that exists at the associated point-in-time during the streaming session.

For explanatory purposes, FIG. 2 depicts the session interaction data 140 that the client application 120 of FIG. 1 incrementally generates based on exemplary user interactions that occur during an exemplary streaming session. Five different discrete portions of the session interaction data 140 are depicted along a session timeline 202. The relative positions of the depicted portions of the session interaction data 140 along the session timeline 202 reflect the temporal order in which the corresponding exemplary user interactions occur during the exemplary streaming session. As shown, the session interaction data 140 includes recommendation trigger data 210, women-focused browsing data 230, recommendation trigger data 250, food-focused browsing data 270, and recommendation trigger data 290.

During a first portion of the exemplary streaming session, the client application 120 incrementally generates and sets the session interaction data 140 equal to the recommendation trigger data 210 based on one or more user interactions that the monitoring engine 130 interprets as a first recommendation trigger. For example, the user interactions could correspond to a user logging into a streaming media service via the GUI 102 and/or navigating to a home page within the GUI 102.

In response to the first recommendation trigger (as depicted via a dashed arrow), the client application 120 generates a recommendation request 150(1) and transmits the recommendation request 150(1) to the in-session recommendation application 160(1). Referring back to FIG. 1, the recommendation request 150(1) and the in-session recommendation application 160(1) are instances of the recommendation request 150 and the in-session recommendation application 160, respectively, at a first point-in-time corresponding to the first recommendation trigger.

More precisely, the recommendation request 150(1) includes the user ID 152, the language 154, the country 156, and a first version of the session interaction data 140. Notably, the client application 120 generates the first version of the session interaction data 140 prior to generating the women-focused browsing data 230, the recommendation trigger data 250, the food-focused browsing data 270, and the recommendation trigger data 290. In particular, the first version of the session interaction data 140 does not include any browsing-related data.

As shown, the in-session recommendation application 160(1) generates a ranked item list 194(1) based on the recommendation request 150(1) and the media database 104. The in-session recommendation application 160(1) includes, without limitation, a feature engine 170(1), feature vectors 168(1), scores 192(1), and the ranked item list 194(1) that are first instances of the feature engine 170, the feature vectors 168, scores 192, and the ranked item list 194, respectively, depicted in FIG. 1.

The feature engine 170(1) retrieves from the media database 104 a different item feature vector (not shown) for each media title included in a catalog of media titles and preference-related data associated with the user ID. The feature engine 170(1) also retrieves from the media database 104 the X most recent session snapshots associated with the user ID, where X is equal to the minimum of a predetermined cross-session limit and the total number of session snapshots associated with the user ID.

The feature engine 170(1) generates a request feature vector 220(1) based on the first version of the session interaction data 140, the user ID 152, the language 154, the country 156, the retrieved preference-related data, and the retrieved session snapshots. For explanatory purposes, the request feature vector 220(1) includes, without limitation, viewed genre values 222, browsed genre values 224(1), and (as depicted via ellipses) any number and/or types of other feature values.

The feature engine 170(1) computes the viewed genre values 222 for exemplary viewed genre features based on the retrieved preference-related data and the retrieved session snapshots. The feature engine 170(1) computes browsed genre values 222(1) for exemplary browsed genre features based on any browsing-related data included in the first version of the session interaction data 140. As noted previously herein, the first version of the session interaction data 140 included in the recommendation request 150(1) does not include any browsing-related data. Consequently, as depicted by the notation “a11:0.0”, the feature engine 170(1) sets each of the browsed genre values 222(1) equal to 0.0. The browsed genre value 222(1) indicates that from the beginning of the exemplary streaming session through the first point-in-time during the exemplary streaming session, no browsing occurred via the GUI 102.

As shown, the in-session recommendation application 160(1) generates the feature vectors 168(1) based on the request feature vector 220(1) and the item feature vectors. More specifically, for each media title included in a catalog of media titles, the in-session recommendation application 160(1) aggregates an item feature vector associated with the media title and the request feature vector 220(1) to generate a different feature vector. The in-session recommendation application 160(1) independently executes a trained machine learning model 190(1) on each of the feature vectors 168(1) to generate the scores 192(1). The trained machine learning model 190(1) is a first instance of the trained machine learning model 190 of FIG. 1. The in-session recommendation application 160(1) ranks the media titles based on the scores 192(1) and then filters-out all but the fifteen highest-ranked media titles to generate the ranked item list 194(1).

As shown, the media titles ranked first through fifteenth as per the ranked item list 194(1) are, respectively, Cocomelon, Shrek, Shrek Forever After, The Rental, Adam Project, Is it Cake?, Trivia Quest, The Cuphead Show, Shrek 2, 365 Days, Naruto, The Blind Side, Better Call Saul, Squid Game, and Bridgerton.

The in-session recommendation application 160(1) transmits the ranked item list 194(1) to the client application 120. As described previously herein in conjunction with FIG. 1, the client application 120 generates a first recommendation based on the ranked item list 194(1). In some embodiments, the first recommendation is at least a portion of the ranked item list(1). The client application 120 then causes at least a portion of the first recommendation to be displayed within the GUI 102.

Because values for the viewed genre features are not dependent on user interactions during the exemplary streaming session, the viewed genre values 222 are unchanged throughout the exemplary streaming session. To facilitate reuse of the viewed genre values 222, the feature engine 170(1) stores in the media database 104 the viewed genre values 222 and associated metadata identifying the exemplary streaming session.

During a second portion of the exemplary streaming session, the client application 120 incrementally generates and adds to the session interaction data 140 the women-focused browsing data 230 based on one or more user interactions associated with browsing categories, genres, media titles, or any combination thereof that are focused on women. For example, the user interactions could correspond to a user clicking on thumbnails displayed within the GUI 102 to view summaries of corresponding media title(s) that are focused on women as per associated metadata (not shown).

During a third portion of the exemplary streaming session, the client application 120 incrementally generates and adds to the session interaction data 140 the recommendation trigger data 250 corresponding to one or more user interactions that the client application 120 interprets as a second recommendation trigger. For example, the user interactions could correspond to a user navigating to a search page or a home page within the GUI 102.

In response to the second recommendation trigger (and as depicted via a dashed arrow), the client application 120 generates a recommendation request 150(2) and transmits the recommendation request 150(2) to the in-session recommendation application 160(2). Referring back to FIG. 1, the recommendation request 150(2) and the in-session recommendation application 160(2) are instances of the recommendation request 150 and the in-session recommendation application 160, respectively, at a second point-in-time corresponding to the second recommendation trigger. The recommendation request 150(2) includes the user ID 152, the language 154, the country 156, and a second version of the session interaction data 140 that includes the recommendation trigger data 210, the women-focused browsing data 230, and the recommendation trigger data 250.

As shown, the in-session recommendation application 160(2) generates a ranked item list 194(2) based on the recommendation request 150(2) and the media database 104. The in-session recommendation application 160(2) includes, without limitation, a feature engine 170(2), feature vectors 168(2), scores 192(2), and the ranked item list 194(2) that are second instances of the feature engine 170, the feature vectors 168, scores 192, and the ranked item list 194, respectively, depicted in FIG. 1.

The feature engine 170(2) retrieves from the media database 104 the same item feature vectors, the same preference-related data, and the same session snapshots that the feature engine 170(1) previously retrieved from the media database 104. Notably, the feature engine 170(2) also retrieves from the media database 104 the viewed genre values 222 associated with the exemplary streaming session.

The feature engine 170(2) generates a request feature vector 220(2) based on the second version of the session interaction data 140, the user ID 152, the language 154, the country 156, the retrieved preference-related data, the retrieved session snapshots, and the viewed genre values 222.

For explanatory purposes, the request feature vector 220(2) includes, without limitation, the viewed genre values 222, browsed genre values 224(2), and (as depicted via ellipses) any number and/or types of other feature values. The feature engine 170(2) computes the browsed genre values 222(2) for the exemplary browsed genre features based on the women-focused browsing data 230 included in the session interaction data 140. As depicted by the notation “women:1.0, others:0.0”, the feature engine 170(2) sets the feature value for a browsed women-focused genre equal to 1.0 and the feature values for all of the other browsed genre features equal to 0.0. The browsed genre values 222(2) indicate that from the beginning of the exemplary streaming session through the second point-in-time during the exemplary streaming session, all of the browsing that occurred via the GUI 102 has been associated with women-focused media titles.

As shown, the in-session recommendation application 160(2) generates the feature vectors 168(2) based on the request feature vector 220(2) and the retrieved item feature vectors. The in-session recommendation application 160(2) independently executes a trained machine learning model 190(2) on each of the feature vectors 168(2) to generate the scores 192(2). The trained machine learning model 190(2) is a second instance of the trained machine learning model 190 of FIG. 1. The in-session recommendation application 160(2) ranks the media titles based on the scores 192(2) and then filters-out all but the fifteen highest-ranked media titles to generate the ranked item list 194(2).

As shown, the media titles ranked first through fifteenth as per the ranked item list 194(2) are, respectively, New Girl, Emily in Paris, Gilmore Girls, Anne with an E, Good Girls, Shrek Forever After, Bridgerton, The Rental, The Cuphead Show, Shrek, Adam Project, Cocomelon, Shrek 2, 365 Days, and Is it Cake?. For explanatory purposes, the media titles Trivia Quest, Naruto, The Blind Side, Better Call Saul, and Squid Game that are included in the ranked item list 194(1) but not in the ranked item list 194(2) are depicted in italics within the ranked item list 194(1). In a complementary fashion, the media titles New Girl, Emily in Paris, Gilmore Girls, Anne with an E, and Good Girls that are included in the ranked item list 194(2) but not in the ranked item list 194(1) are depicted in bold within the ranked item list 194(2).

Unlike the ranked item list 194(1), the ranked item list 194(2) accounts for the women-focused browsing that occurred prior to the second point-in-time during the exemplary streaming session. As illustrated by the differences between the ranked item list 194(1) and the ranked item list 194(2), the ranked item list 194(2) therefore more closely aligns to the actual interests of the user during the exemplary streaming session.

The in-session recommendation application 160(2) transmits the ranked item list 194(2) to the client application 120. As described previously herein in conjunction with FIG. 1, the client application 120 generates a second recommendation based on the ranked item list 194(2). The client application 120 then causes at least a portion of the second recommendation instead of the first recommendation to be displayed within the GUI 102.

During a fourth portion of the exemplary streaming session, the client application 120 incrementally generates and adds to the session interaction data 140 the food-focused browsing data 270 based on one or more user interactions associated with browsing categories, genres, media titles, or any combination thereof that are focused on food. For example, the user interactions could correspond to a user clicking on thumbnails displayed within the GUI 102 to view summaries of corresponding media title(s) that are focused on food as per associated metadata (not shown).

During a fifth portion of the exemplary streaming session, the client application 120 incrementally generates and adds to the session interaction data 140 the recommendation trigger data 290 corresponding to one or more user interactions that the client application 120 interprets as a third recommendation trigger. For example, the user interactions could correspond to a user navigating to a search page or a home page within the GUI 102.

In response to the third recommendation trigger (and as depicted via a dashed arrow), the client application 120 generates a recommendation request 150(2) and transmits the recommendation request 150(3) to the in-session recommendation application 160(3). Referring back to FIG. 1, the recommendation request 150(3) and the in-session recommendation application 160(3) are instances of the recommendation request 150 and the in-session recommendation application 160, respectively, at a third point-in-time corresponding to the third recommendation trigger. The recommendation request 150(3) includes the user ID 152, the language 154, the country 156, and a third version of the session interaction data 140 that includes the recommendation trigger data 210, the women-focused browsing data 230, the recommendation trigger data 250, the food-focused browsing data 270, and the recommendation trigger data 290.

As shown, the in-session recommendation application 160(3) generates a ranked item list 194(3) based on the recommendation request 150(3), the media database 104, and the retrieved item feature vectors. The in-session recommendation application 160(3) includes, without limitation, a feature engine 170(3), feature vectors 168(3), scores 192(3), and the ranked item list 194(3) that are third instances of the feature engine 170, the feature vectors 168, scores 192, and the ranked item list 194, respectively, depicted in FIG. 1.

The feature engine 170(3) retrieves from the media database 104 the same preference-related data and the same session snapshots that the feature engine 170(1) and the feature engine 170(2) previously retrieved from the media database 104. The feature engine 170(3) also retrieves from the media database 104 the viewed genre values 222 associated with the exemplary streaming session.

The feature engine 170(3) generates a request feature vector 220(3) based on the third version of the session interaction data 140, the user ID 152, the language 154, the country 156, the retrieved preference-related data, the retrieved session snapshots, and the viewed genre values 222.

For explanatory purposes, the request feature vector 220(2) includes, without limitation, the viewed genre values 222, browsed genre values 224(3), and (as depicted via ellipses) any number and/or types of other feature values. The feature engine 170(3) computes the browsed genre values 222(3) for the exemplary browsed genre features based on the women-focused browsing data 230 and the food-focused browsing data 270 included in the session interaction data 140. As depicted by the notation “food 0.6, women:0.4, others:0.0”, the feature engine 170(3) sets the feature values for a browsed food-focused genre and a browsed women-focused genre equal to 0.6 and 0.4 respectively, and the feature values for all of the other browsed genre features equal to 0.0. The browsed genre values 222(3) indicate that from the beginning of the exemplary streaming session through the third point-in-time during the exemplary streaming session, about sixty percent of the browsing that occurred via the GUI 102 has been associated with food-focused media titles and the remainder of the browsing has been focused on women-focused media titles.

As shown, the in-session recommendation application 160(3) generates the feature vectors 168(3) based on the request feature vector 220(3) and the retrieved item feature vectors. The in-session recommendation application 160(3) independently executes a trained machine learning model 190(3) on each of the feature vectors 168(3) to generate the scores 192(3). The trained machine learning model 190(2) is a second instance of the trained machine learning model 190 of FIG. 1. The in-session recommendation application 160(3) ranks the media titles based on the scores 192(3) and then filters-out all but the fifteen highest-ranked media titles to generate the ranked item list 194(3).

As shown, the media titles ranked first through fifteenth as per the ranked item list 194(3) are, respectively, Street Food Asia, New Girl, Waffles+Mochi, Anne with an E, The Chef Show, Emily in Paris, Gilmore Girls, Good Girls, Shrek Forever After, Bridgerton, The Rental, Adam Project, Is it Cake?, Shrek, and The Cuphead Show. For explanatory purposes, the media titles Cocomelon, Shrek 2, and 365 Days that are included in the ranked item list 194(2) but not in the ranked item list 194(3) are depicted in italics within the ranked item list 194(2). In a complementary fashion, the media titles Street Food Asia, Waffles+Mochi, and The Chef Show that are included in the ranked item list 194(3) but not in the ranked item list 194(2) are depicted in bold within the ranked item list 194(2).

Unlike the ranked items list 194(2), the ranked item list 194(3) accounts for the food-focused browsing that occurred between the second point-in-time and the third point-in-time during the exemplary streaming session. Consequently, as illustrated by the differences between the ranked item list 194(2) and the ranked item list 194(3), the ranked item list 194(3) more closely aligns to the actual interests of the user during the exemplary streaming session.

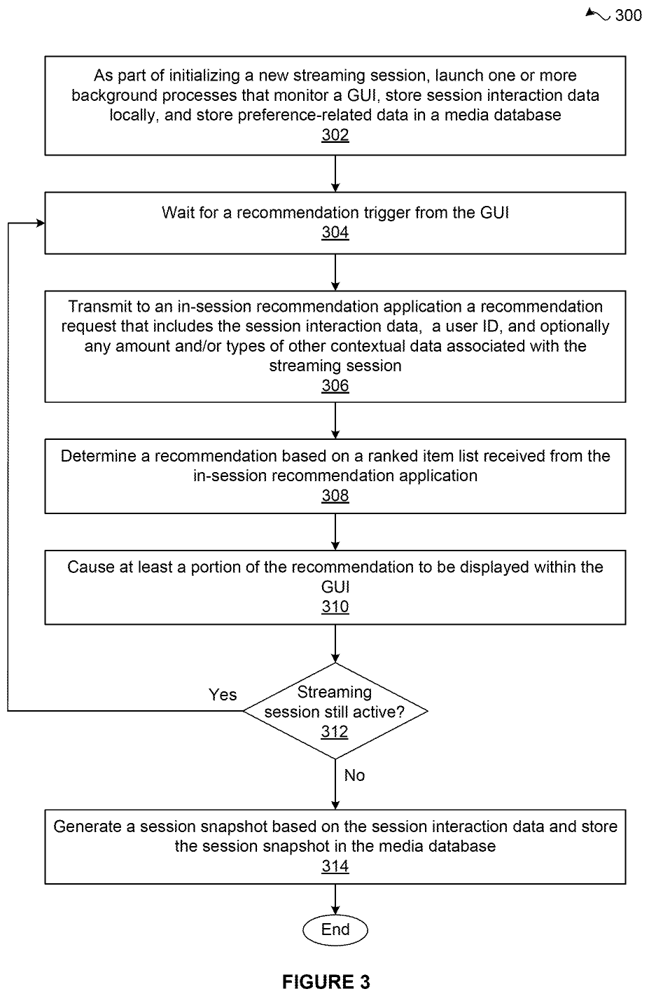

FIG. 3 is a flow diagram of method steps for displaying personalized recommendations within a GUI during a streaming session, according to various embodiments. Although the method steps are described with reference to the systems of FIGS. 1 and 2, persons skilled in the art will understand that any system configured to implement the method steps, in any order, falls within the scope of the embodiments.

As shown, a method 300 begins at step 302, where the client application 120, as part of initializing a new streaming session, launches one or more background processes that monitor a GUI 102, store session interaction data locally, and store preference-related data in a database. At step 304, the client application 120 waits for a recommendation trigger from the GUI 102.

At step 306, the client application 120 transmits to an in-session recommendation application 160 a recommendation request that includes the session interaction data, a user ID, and optionally any amount and/or types of other contextual data associated with the streaming session. In response, the in-session recommendation application 160 uses the trained machine learning model 190 to generate a ranked item list and transmits a response that includes the ranked item list to the client application 120.

The in-session recommendation application 160 can use the trained machine learning model 190 to generate the ranked item list in any technically feasible fashion.

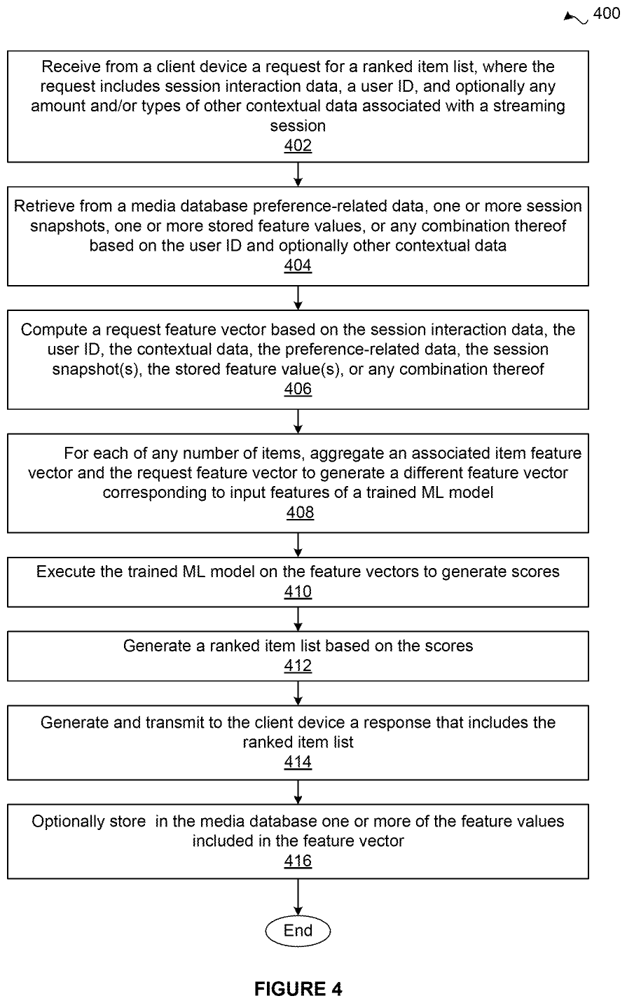

In some embodiments, the in-session recommendation application 160 implements at least a portion of the steps described below in conjunction with FIG. 4 to generate the ranked item list based on at least one of the session interaction data, the user ID, the contextual data, user preference data, one or more session snapshots associated with one or more historical streaming sessions, or any combination thereof.

At step 308, the client application 120 generates a recommendation based on the ranked item list received from the in-session recommendation application 160. At step 310, the client application 120 causes at least a portion of the recommendation to be displayed within the GUI 102. At step 312, the client application 120 determines whether the streaming session is still active. If, at step 312, the client application 120 determines that the streaming session is still active, then the method 300 returns to step 304, where the client application 120 waits for a recommendation trigger from the GUI 102.

If, however, at step 312, the client application 120 determines that the streaming session is no longer active, then the method proceeds to step 314. At step 314, the client application 120 generates a session snapshot based on the session interaction data and stores the session snapshot in the database or another database. The client application 120 then terminates.

FIG. 4 is a flow diagram of method steps for generating a ranked item list, according to various embodiments. Notably, the ranked item list is generated based on user interactions during a streaming session, historical preference data associated with a user, and optionally one or more session snapshots associated with one or more prior streaming sessions. Although the method steps are described with reference to the systems of FIGS. 1 and 2, persons skilled in the art will understand that any system configured to implement the method steps, in any order, falls within the scope of the embodiments.

As shown, a method 400 begins at step 402, where the in-session recommendation application 160 receives from a client device a request for a ranked item list, where the request includes session interaction data, a user ID, and optionally any amount and/or types of other contextual data associated with a streaming session. At step 404, the in-session recommendation application 160 retrieves from one or more databases preference-related data, one or more session snapshots, one or more stored feature values, or any combination thereof based on the user ID and optionally other contextual data.

At step 406, the in-session recommendation application 160 computes a request feature vector based on the session interaction data, the user ID, the contextual data, the preference-related data, the session snapshot(s), the stored feature value(s), or any combination thereof. At step 408, for each of any number of items, the in-session recommendation application 160 aggregates an associated item feature vector and the request feature vector to generate a different feature vector corresponding to the input features of a trained machine learning model.

At step 410, the in-session recommendation application 160 executes the trained machine learning model on the feature vectors to generate scores. At step 412, the in-session recommendation application 160 generates a ranked item list based on the scores. At step 414, the in-session recommendation application 160 generates and transmits to the client device a response that includes the ranked item list. At step 416, the in-session recommendation application 160 optionally stores one or more of the feature values included in the feature vector in the media database 104.

In sum, the disclosed techniques can be used to generate personalized recommendations that account for user interactions during streaming sessions. In some embodiments, a client application monitors user interactions during a streaming session to incrementally generate session interaction data. Throughout the streaming session, upon detecting a recommendation trigger, the client application transmits a recommendation request to an in-session recommendation application. The recommendation request includes the session interaction data, a user ID, and any amount and/or types of other contextual data associated with the streaming session.

The in-session recommendation application uses a trained machine learning model to generate scores based on the session interaction data, historical preference-related data, zero or more session snapshots, and any amount of relevant contextual data. Each session snapshot corresponds to session interaction data recorded during a different previous streaming session associated with the user ID. Each score is associated with a different media title and predicts a likelihood that a user corresponding to the user ID is going to stream the media title during the streaming session. The in-session recommendation application ranks and optionally filters the media titles based on the scores to generate a ranked item list. The in-session recommendation application transmits the ranked item list to the client application. Upon receiving the ranked item list, the client application generates and displays within the GUI any number of GUI elements that graphically depict a recommendation that includes one or more of the highest-ranked media titles in the ranked item list.

At least one technical advantage of the disclosed techniques relative to the prior art is that, with the disclosed techniques, personalized recommendations can be generated and displayed within a GUI during a streaming session based on historical preferences and user interactions that have occurred during that streaming session. In that regard, with the disclosed techniques, a machine learning model is implemented that is trained to generate personalized recommendations for a given user that account for both the historical preferences of that user as well as the interactions of that user during a current streaming session. Because the interactions of a user that occur during a given streaming session usually correlate to the actual interests of that user, the accuracy, and therefore usefulness, of personalized recommendations that are based on those interactions can be increased relative to recommendations that are generated using prior art techniques. These technical advantages provide one or more technological advancements over prior art approaches.
1. In some embodiments, a computer-implemented method for generating recommendations for users during streaming sessions comprises generating a first plurality of feature values for a first plurality of features associated with a trained machine learning model based on a first set of user interactions that have occurred via a first graphical user interface (GUI) during a current streaming session; executing the trained machine learning model on at least the first plurality of feature values and a first feature value associated with a first item to generate a first score; generating a first recommendation based on the first score and at least a second score that is associated with both a second item and the first set of user interactions; and displaying the first recommendation within the first GUI.
2. The computer-implemented method of clause 1, wherein generating the first recommendation comprises computing a ranked item list based on the first score and at least the second score.
3. The computer-implemented method of clauses 1 or 2, further comprising computing the first feature value based on first metadata associated with the first item.
4. The computer-implemented method of any of clauses 1-3, wherein generating the first plurality of feature values comprises computing a second feature value based on at least one of the first set of user interactions, preference-related data associated with a first user, or a snapshot of user interactions associated with both the first user and a previous streaming session.
5. The computer-implemented method of any of clauses 1-4, wherein the first set of user interactions indicates at least one of a first amount of time spent hovering over a third item, a selection of the third item, or a second amount of time spent streaming the third item.
6. The computer-implemented method of any of clauses 1-5, further comprising monitoring the first GUI during the current streaming session to determine the first set of user interactions.
7. The computer-implemented method of any of clauses 1-6, further comprising generating a snapshot of user interactions based on the first set of user interactions, and storing the snapshot in a first memory.
8. The computer-implemented method of any of clauses 1-7, further comprising during a different streaming session that is subsequent to the current streaming session, generating a second plurality of feature values for the first plurality of features based on the snapshot; executing the trained machine learning model on at least the second plurality of feature values and the first feature value to generate a third score; generating a second recommendation based on the first score and at least a fourth score that is associated with the second item; and displaying the second recommendation within a second GUI.
9. The computer-implemented method of any of clauses 1-8, further comprising performing one or more machine learning operations on a machine learning model based on preference-related data associated with a plurality of users, a plurality of snapshots of user interactions associated with a plurality of historical streaming sessions, and a plurality of items streamed during the plurality of historical streaming sessions to generate the trained machine learning model.
10. The computer-implemented method of any of clauses 1-9, wherein the preference-related data includes at least one of a streaming history or one or more user ratings of one or more items.
11. In some embodiments, one or more non-transitory computer readable media include instructions that, when executed by one or more processors, cause the one or more processors to generate recommendations for users during streaming sessions by performing the steps of generating a first plurality of feature values for a first plurality of features associated with a trained machine learning model based on a first set of user interactions that have occurred via a graphical user interface (GUI) during a current streaming session; executing the trained machine learning model on at least the first plurality of feature values and a first feature value associated with a first item to generate a first score; generating a first recommendation based on the first score and at least a second score that is associated with both a second item and the first set of user interactions; and displaying the first recommendation within the GUI.
12. The one or more non-transitory computer readable media of clause 11, wherein generating the first recommendation comprises computing a ranked item list based on the first score and at least the second score.
13. The one or more non-transitory computer readable media of clauses 11 or 12, wherein generating the first plurality of feature values comprises computing a second feature value based on at least one of the first set of user interactions, a country associated with the current streaming session, a user identifier associated with the current streaming session, or a language associated with the current streaming session.
14. The one or more non-transitory computer readable media of any of clauses 11-13, wherein generating the first plurality of feature values comprises computing a second feature value based on at least one of the first set of user interactions, preference-related data associated with a first user, or a snapshot of user interactions associated with both the first user and a previous streaming session.
15. The one or more non-transitory computer readable media of any of clauses 11-14, wherein the preference-related data includes at least one of a streaming history or one or more user ratings of one or more items.
16. The one or more non-transitory computer readable media of any of clauses 11-15, further comprising computing a second plurality of feature values for the first plurality of features based on the first set of user interactions and at least one other user interaction that occurs via the GUI subsequent to the displaying of the first recommendation within the GUI; executing the trained machine learning model on at least the second plurality of feature values and the first feature value to generate a third score; generating a second recommendation based on the third score and at least a fourth score that is associated with both the second item and the at least one other user interaction; and displaying the second recommendation instead of the first recommendation within the GUI.
17. The one or more non-transitory computer readable media of any of clauses 11-16, further comprising generating a snapshot of user interactions based on the first set of user interactions, and storing the snapshot in a first memory.
18. The one or more non-transitory computer readable media of any of clauses 11-17, further comprising performing one or more training operations on a machine learning model based on preference-related data associated with a plurality of users, a plurality of snapshots of user interactions associated with a plurality of historical streaming sessions, and a plurality of items streamed during the plurality of historical streaming sessions to generate the trained machine learning model.
19. The one or more non-transitory computer readable media of any of clauses 11-18, wherein the first item comprises a movie, an episode of a television show, or a podcast.
20. In some embodiments, a system comprises one or more memories storing instructions and one or more processors coupled to the one or more memories that, when executing the instructions, perform the steps of generating a first plurality of feature values for a first plurality of features associated with a trained machine learning model based on a first set of user interactions that have occurred via a graphical user interface (GUI) during a current streaming session; executing the trained machine learning model on at least the first plurality of feature values and a first feature value associated with a first item to generate a first score; generating a first recommendation based on the first score and at least a second score that is associated with both a second item and the first set of user interactions; and displaying the first recommendation within the GUI.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory, Flash memory, an optical fiber, a portable compact disc read-only memory, an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating recommendations for users during streaming sessions, the method comprising:
generating a first plurality of feature values for a first plurality of features associated with a trained machine learning model based on a first set of user interactions that have occurred via a first graphical user interface (GUI) during a current streaming session;
executing the trained machine learning model on at least the first plurality of feature values and a first feature value associated with a first item to generate a first score;
generating a first recommendation based on the first score and at least a second score that is associated with both a second item and the first set of user interactions; and
displaying the first recommendation within the first GUI.

2. The computer-implemented method of claim 1, wherein generating the first recommendation comprises computing a ranked item list based on the first score and at least the second score.

3. The computer-implemented method of claim 1, further comprising computing the first feature value based on first metadata associated with the first item.

4. The computer-implemented method of claim 1, wherein generating the first plurality of feature values comprises computing a second feature value based on at least one of the first set of user interactions, preference-related data associated with a first user, or a snapshot of user interactions associated with both the first user and a previous streaming session.

5. The computer-implemented method of claim 1, wherein the first set of user interactions indicates at least one of a first amount of time spent hovering over a third item, a selection of the third item, or a second amount of time spent streaming the third item.

6. The computer-implemented method of claim 1, further comprising monitoring the first GUI during the current streaming session to determine the first set of user interactions.

7. The computer-implemented method of claim 1, further comprising generating a snapshot of user interactions based on the first set of user interactions, and storing the snapshot in a first memory.

8. The computer-implemented method of claim 7, further comprising:
during a different streaming session that is subsequent to the current streaming session, generating a second plurality of feature values for the first plurality of features based on the snapshot;
executing the trained machine learning model on at least the second plurality of feature values and the first feature value to generate a third score;
generating a second recommendation based on the first score and at least a fourth score that is associated with the second item; and
displaying the second recommendation within a second GUI.

9. The computer-implemented method of claim 1, further comprising performing one or more machine learning operations on a machine learning model based on preference-related data associated with a plurality of users, a plurality of snapshots of user interactions associated with a plurality of historical streaming sessions, and a plurality of items streamed during the plurality of historical streaming sessions to generate the trained machine learning model.

10. The computer-implemented method of claim 9, wherein the preference-related data includes at least one of a streaming history or one or more user ratings of one or more items.

11. One or more non-transitory computer readable media including instructions that, when executed by one or more processors, cause the one or more processors to generate recommendations for users during streaming sessions by performing the steps of:
generating a first plurality of feature values for a first plurality of features associated with a trained machine learning model based on a first set of user interactions that have occurred via a graphical user interface (GUI) during a current streaming session;
executing the trained machine learning model on at least the first plurality of feature values and a first feature value associated with a first item to generate a first score;
generating a first recommendation based on the first score and at least a second score that is associated with both a second item and the first set of user interactions; and
displaying the first recommendation within the GUI.

12. The one or more non-transitory computer readable media of claim 11, wherein generating the first recommendation comprises computing a ranked item list based on the first score and at least the second score.

13. The one or more non-transitory computer readable media of claim 11, wherein generating the first plurality of feature values comprises computing a second feature value based on at least one of the first set of user interactions, a country associated with the current streaming session, a user identifier associated with the current streaming session, or a language associated with the current streaming session.

14. The one or more non-transitory computer readable media of claim 11, wherein generating the first plurality of feature values comprises computing a second feature value based on at least one of the first set of user interactions, preference-related data associated with a first user, or a snapshot of user interactions associated with both the first user and a previous streaming session.

15. The one or more non-transitory computer readable media of claim 14, wherein the preference-related data includes at least one of a streaming history or one or more user ratings of one or more items.

16. The one or more non-transitory computer readable media of claim 11, further comprising:
computing a second plurality of feature values for the first plurality of features based on the first set of user interactions and at least one other user interaction that occurs via the GUI subsequent to the displaying of the first recommendation within the GUI;
executing the trained machine learning model on at least the second plurality of feature values and the first feature value to generate a third score;
generating a second recommendation based on the third score and at least a fourth score that is associated with both the second item and the at least one other user interaction; and
displaying the second recommendation instead of the first recommendation within the GUI.

17. The one or more non-transitory computer readable media of claim 11, further comprising generating a snapshot of user interactions based on the first set of user interactions, and storing the snapshot in a first memory.

18. The one or more non-transitory computer readable media of claim 11, further comprising performing one or more training operations on a machine learning model based on preference-related data associated with a plurality of users, a plurality of snapshots of user interactions associated with a plurality of historical streaming sessions, and a plurality of items streamed during the plurality of historical streaming sessions to generate the trained machine learning model.

19. The one or more non-transitory computer readable media of claim 11, wherein the first item comprises a movie, an episode of a television show, or a podcast. A system comprising:
one or more memories storing instructions; and
one or more processors coupled to the one or more memories that, when executing the instructions, perform the steps of:
generating a first plurality of feature values for a first plurality of features associated with a trained machine learning model based on a first set of user interactions that have occurred via a graphical user interface (GUI) during a current streaming session;
executing the trained machine learning model on at least the first plurality of feature values and a first feature value associated with a first item to generate a first score;
generating a first recommendation based on the first score and at least a second score that is associated with both a second item and the first set of user interactions; and
displaying the first recommendation within the GUI.
